(19) United States
(12) Patent Application Publication
(10) Pub. No.: US 2011/0125796 A1
(43) Pub. Date: May 26, 2011

(54) SERVICE FOR CREATING ONLINE REVIEW SITE AND FACILITATING WORD-OF-MOUTH ONLINE

(75) Inventor: Herb SINGH, Austin, TX (US)

(73) Assignee: The Review Book, LLC, Austin, TX (US)

(21) Appl. No.: 12/623,742

(22) Filed: Nov. 23, 2009

(51) Int. Cl. G06F 17/30; G06F 3/01

(52) U.S. Cl. 707/781; 707/802; 707/E17.005; 715/760; 707/E17.116

(57) ABSTRACT

A system and method of gathering, validating and disseminating reviews about an organization is disclosed. Reviews from customers of businesses are invited and thereafter selectively provided to third parties using various means.

### FIELD OF THE INVENTION

The present invention relates to a system and method for gathering reviews about organizations, validating the reviews and disseminating such reviews.

### BACKGROUND OF THE RELATED ART

Customer reviews may be useful in understanding the customer's needs and concerns as well as in identifying the areas of improvement for a business. Further, customer reviews and feedback may provide an opportunity for businesses to assess their strengths and weaknesses, stay in touch with their clients, sense opportunities for growth in future and also add to their existing customer base. Growth of local businesses in particular is dependent upon word-of-mouth feedback of their customers.

However, the shortcoming of a related art word-of-mouth feedback is its limited reach and coverage. Further, it is very difficult to obtain customer's word-of-mouth feedback from a significant proportion of customers according to the related art.

In the related art, several methods are used to collect customer's reviews. However, related art methods or systems do not allow for disseminating the word-of-mouth feedback to a large number of potential customers. Thus, there is an unmet need for an efficient method of gathering review or feedback from the customer to analyze the organization. There is also a need for a system or method to allow customer review at any time to gather reviews.

### SUMMARY

An aspect of the exemplary embodiments is to gather and manage reviews of an organization and to provide the reviews to potential customers of the organization.

Another aspect of the exemplary embodiments is to provide a method for gathering reviews about an organization, validating the reviews and disseminating the reviews to third parties. The method comprises storing particulars of an organization including, but not limited to name, type of business, contact information, validation information, product information etc in a database; storing information about customers of the business or organization including, but not limited to customer details, review details, past review, customer id, history etc in the database; inviting the customer to review the organization using the information stored in the database; storing a review by the customer in the database; analyzing the review; and selectively providing the review to targeted users.

Another aspect of the exemplary embodiments is to provide a system for reviewing an organization. The system comprises a content management server including a database configured to store data, wherein the data comprises information about the organization and information about an entity having a relationship with the organization; a first user interface configured to receive an input from the server, wherein the first user interface comprises a first set of tools for soliciting review from the entity and a second set of tools for processing the review received from the entity; and a second user interface that is linked to the server, the second user interface selectively providing the review received from the customer to at least one third party.

It is still another aspect of the exemplary embodiments to provide a method that would be used by an organization especially among its local clientele to ascertain and enhance its popularity and seek feedback from its clients. The enhancement would result from displaying feedback/reviews/comments from customers to third parties. The addition of unique growing content specific to the services/products of an organization may also result in that organization being more likely to be found in a search engine results.

It is still another aspect of the exemplary embodiments to provide a method for getting a local businesses' word-of-mouth feedback online. The method comprises inviting existing customers of the local business to provide a word-of-mouth feedback about the business, validating it; and displaying the said feedback online.

The foregoing and other objects, embodiments, features and advantages of the present invention will become apparent from the following more particular description of the invention and the claims appended thereto.

### BRIEF DESCRIPTION OF DRAWINGS

FIG. 1 illustrates a block diagram showing an exemplary system for gathering, managing and selectively displaying reviews of an organization;

FIG. 2 illustrates a flowchart of a method for gathering, managing and displaying reviews in accordance with an exemplary embodiment;

FIG. 3 illustrates a block diagram of content management server in accordance with an exemplary embodiment;

FIG. 4 illustrates a block diagram of first user interface in accordance with an exemplary embodiment;

FIG. 5 illustrates first user interface in accordance with an exemplary embodiment;

FIG. 6 illustrates a work flow to invite an entity by using the email invitation method in accordance with an exemplary embodiment;

FIG. 7 illustrates a work flow to invite an entity by using the printed invitation method in accordance with an exemplary embodiment;

FIG. 8 illustrates a work flow to generate code for a widget in accordance with an exemplary embodiment; and

FIG. 9 illustrates a work flow to submit a review online on a website in accordance with an exemplary embodiment.

### DETAILED DESCRIPTION

An exemplary embodiment is directed to a system and method for review of an organization by an entity such as, but not limited to an existing customer, supplier or vendor related to said organization and selectively providing said reviews to at least one third party by either publishing said reviews online or printing said reviews in a publication or providing said reviews by any other medium.

Numerous specific details are provided such as examples of components and/or mechanisms to provide a thorough understanding of the various exemplary embodiments. One skilled in the relevant art will recognize however, that an exemplary embodiment can be practiced without one or more of the specific details, or with other apparatus, systems, assemblies, methods, components, materials, parts, and/or the like. In other instances, well-known structures, materials or operations are not specifically shown or described in detail to avoid obscuring aspects of exemplary embodiments and for the sake of clarity.

Although the exemplary embodiment is directed to gathering, managing and selective displaying of the reviews about the organizations, the exemplary may be applied in connection with polling, surveying, product development research, market research, usability testing, business-to-consumer (B2C) commercial transactions, business-to-business (B2B) commercial transactions, or any other suitable activity for which the gathering and managing of entity reviews may be desirable. Those skilled in the art will readily appreciate the application to such activities.

Additionally, in an exemplary embodiment, hardware and software components are used for gathering, managing and providing reviews about the organization.

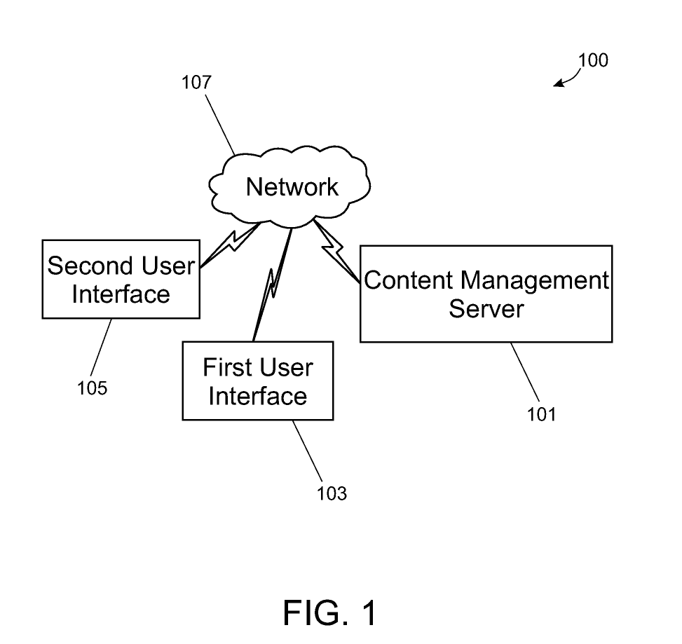

FIG. 1 is a block diagram showing an exemplary system 100 for gathering, managing and selectively displaying reviews of an organization. The system 100 includes a content management server 101, a first user interface 103 and a second user interface 105, which are commonly connected via network 107. Network 107 may include, but is not limited to, a local area network (LAN), metropolitan area network (MAN), wide area network (WAN), a global communications network such as the Internet, or the like.

Content management server 101, first user interface 103 and second user interface 105 are disclosed in FIG. 1 as being connected via a network 107. However, it is also possible for the components to be coupled via multiple networks of the same type or different types.

The content management server 101 controls various processes in accordance with the exemplary embodiments and stores various types of information, for example but not by way of limitation, information about organization, information about entities related to the organization, reviews/feedbacks/comments/ratings about the organization, and programming instructions.

The first user interface 103 is an administration panel that provides an operator with tools for managing components of the system 100 and for administering or performing one or more processes. In one exemplary embodiment, the access to the first user interface 103 is limited only to an administrator by a username and a password. The administrator could be an authorized user who has been assigned the details required to access the first user interface 103.

The second user interface 105 is used to provide the reviews to the third party. In another exemplary embodiment, the second user interface 105 also provides a user with an input interface for submitting the review about the organization.

In still another exemplary embodiment, a method for gathering and/or displaying reviews is provided. The method comprises storing first information about an organization in a database; storing second information about an entity that is related to the organization in the database; inviting the entity to review the organization using the first information and the second information; storing a review by the entity in the database; analyzing the review; and selectively providing the review to at least one third party.

The “organization” may include but is not limited to professionals (such as doctors, accountants, attorneys, or the like), local businesses, large businesses, and service providers, as well as other entities such as devices and software.

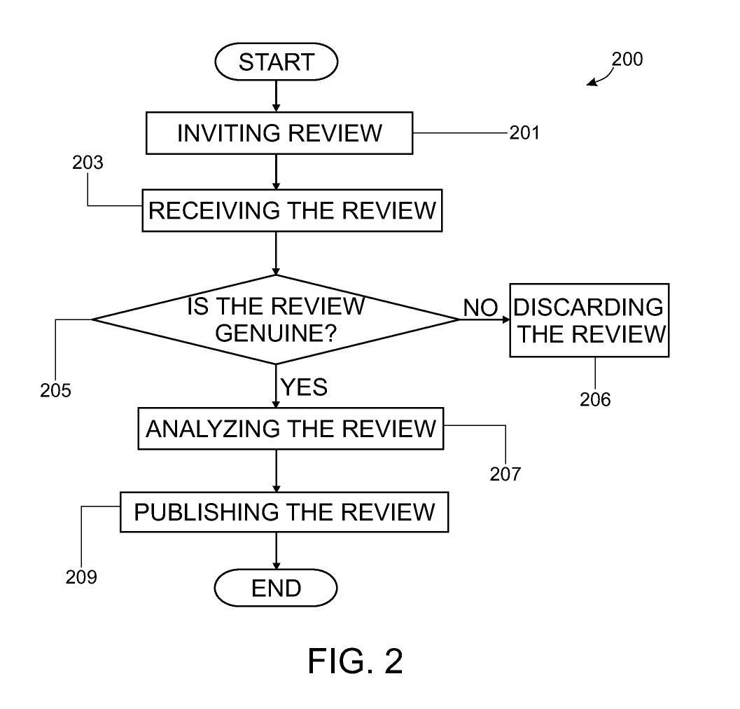

FIG. 2 is a flowchart illustrating a process 200 for gathering, managing and displaying reviews of the organization in accordance with one exemplary embodiment. The exemplary process 200 begins at 201 where the information stored in the content management server 101 is used to invite an entity related to the organization to provide a review or a feedback or a comment about the organization. The entity can be any person related to the organization including, but not limited to, a customer, a vendor or a supplier of the organization. The invitation could be a non-electronic invitation such as printed invitation, or could be an electronic invitation such as an e-mail message, a short messaging service (SMS) or a phone call. In an exemplary embodiment, the invitation is sent to the entity using the tools provided on the first user interface 103. However, any other method or system for inviting reviews can be used without departing from the spirit and scope of the present invention.

In 203, a review or a feedback or a comment is received from the entity in response to the invitation. Depending upon the type of invitation method used for inviting the entity, the review can be received in various forms, including but not limited to a printed review (hard copy), online submitted review, review received by SMS, review received by e-mail or review received by audio input. The received review is stored electronically in the content management server 101.

The review can be entered into the second user interface 105 by the entity or can be received at an intermediary and then entered into the second user interface 105. The review is then stored electronically in the content management server 101 for further analysis.

In 205, the genuineness of the review is verified. A review is considered genuine if it relates to the organization. If the review is not found to be genuine the review is discarded (206); if the review is found to be genuine, the review is analyzed (207) to obtain further information that may be valuable to the organization or to a third party. Further, 207 is performed using the tools on the first user interface 103. The analysis of reviews can be used for various purposes such as generating a list of most popular and least popular product/service of the organization, identifying various areas of improvement for the organization, or the like.

The genuineness of the review may be verified by various procedures, including but not limited to:—
a. Checking if the reviewer is found in the database of the organization.
b. Validating the reviewer.
c. Receiving the validation

Several other validation procedures are known in the art, including but are not limited to checking for spamming, sabotage, abuse and misuse of the system by unauthorized users or unauthorized reviewers.

In 209, the reviews and/or the analysis of the reviews are published, i.e., provided to at least one third party for viewing and evaluating. The reviews can be provided to the third party by electronic or non-electronic means. The third party can be a party, person or system including but not limited to prospective customer, supplier, vendor, or organization, as well as a system, device, or the like.

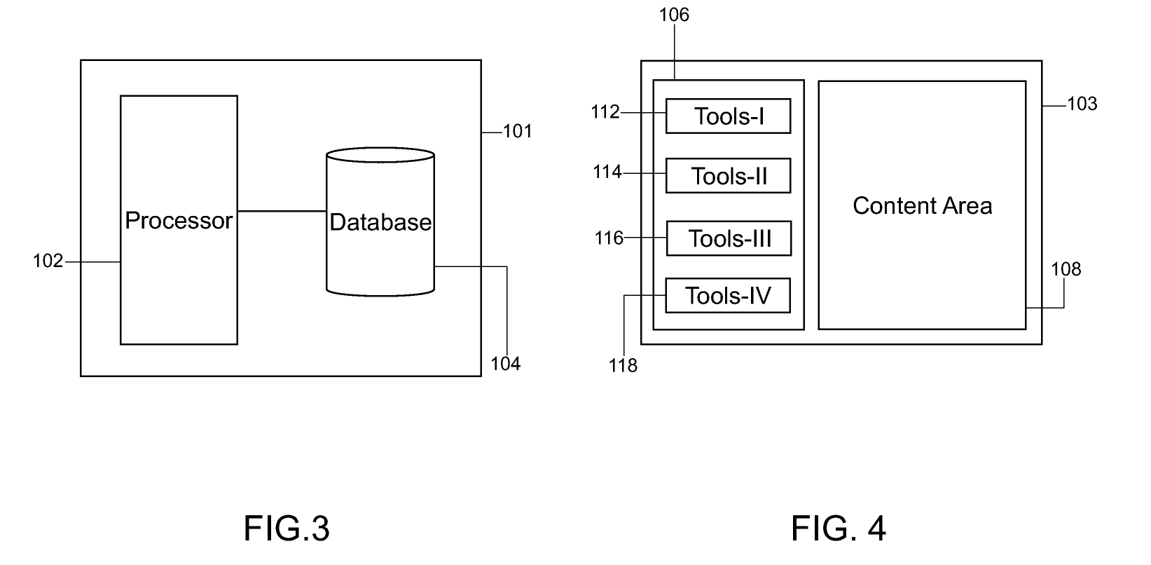

FIG. 3 illustrates components of the content management server 101 according to an exemplary embodiment. The content management server 101 includes a processor 102 and a database 104. The processor 102 can be a microprocessor, personal computer, workstation, controller, microcontroller, state machine, or any other processing machine. The processor 102 can read information from, and write information to, the database and is used to execute various programming instructions installed thereon or stored in the database.

The database 104 includes a storage medium configured to store at least first information and second information, wherein the first information relates to the organization and the second information relates to an entity that is related to the organization such as, but not limited to, a customer, a vendor or a supplier of the organization. The information about the organization includes an organization name, type of organization, services offered by the organization, contact information of the organization, reviews or feedbacks or comments received by the organization from its entities and the like. The information about the entity includes an entity name, contact information of the entity such as address, phone number and e-mail address, product or service of the organization used by the entity and the like. The database 104 may optionally be configured as a set of high-speed, high capacity hard drives, even though any form of volatile storage, non-volatile storage, removable storage, fixed storage, random access storage, sequential access storage, permanent storage, erasable storage, and the like could be used. Further, two or more databases can also be used for storing information. The database may comprise random access memory (“RAM”), and may be used to store the programming instructions executed by the processor. In an alternative embodiment, the database or storage medium may be integral to the processor.

FIG. 4 illustrates various components of the first user interface 103 in accordance with an exemplary embodiment. The first user interface 103 includes a tools area 106 and a content area 108. The tools area 106 includes a first set of tools 112 (Tools-I) for soliciting reviews or comments or feedbacks from the entity, a second set of tools 114 (Tools-II) for managing and analyzing the reviews received from the entity, a third set of tools 116 (Tools-III) for managing the second user interface 105 and a fourth set of tools 118 (Tools-IV) for managing information stored in the database. When a tool is selected from the tools area 106, the content related to that tool is displayed in the content area 108.

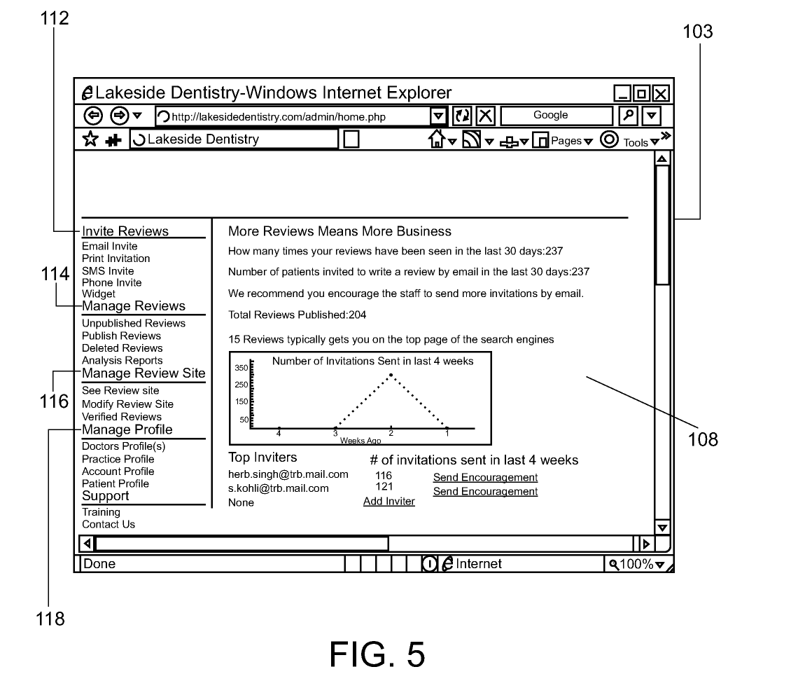

In another exemplary embodiment, the first user interface 103 is a web based application such as a webpage or a website as shown in FIG. 5. In this exemplary embodiment, the organization is Lakeside Dentistry (a professional) and the reviewers of the said organization are entities (patients of the professional).

In another exemplary embodiment, the first set of tools 112 that are used for soliciting reviews or comments or feedbacks from the entity comprises an e-mail invite, a customizable printed invitation, a SMS invite, a phone invite and a widget which is defined below for the purpose of this disclosure. However, any other tool or method for inviting the reviews from the organization can be used. The second set of tools 114 can be used to manage unpublished reviews, published reviews, deleted reviews, or analysis reports. The third set of tools 116 can be used to manage the review site by seeing, modifying or verifying the review site. The fourth set of tools 118 can be used to manage profiles of doctors, practices, accounts, and patients.

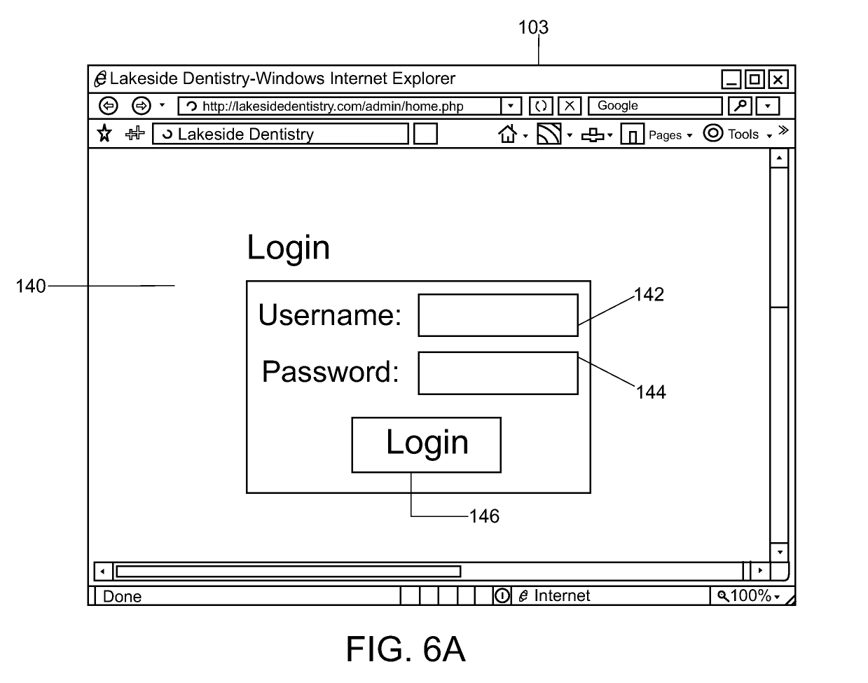

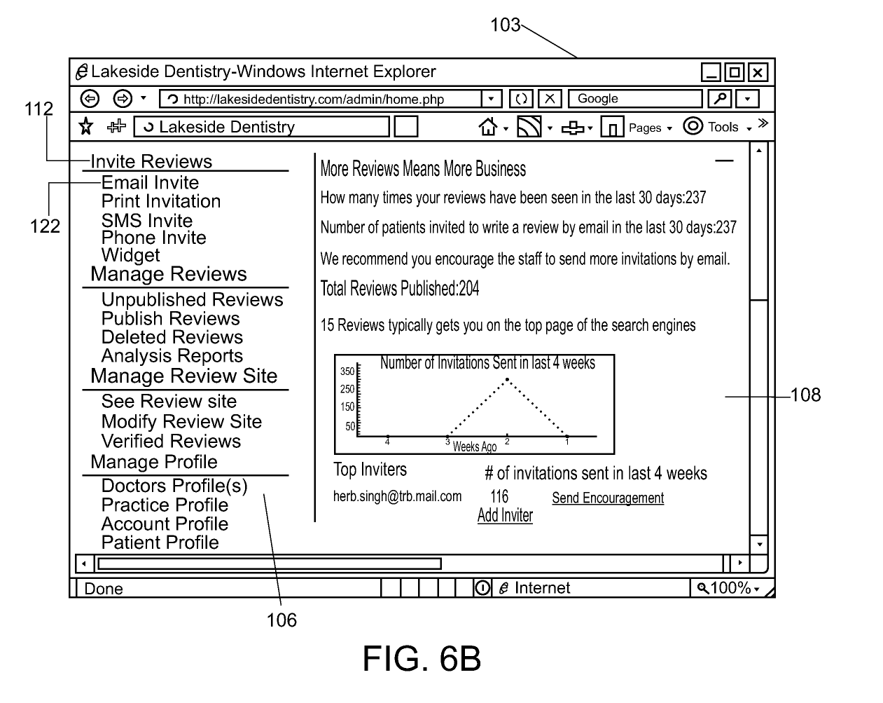

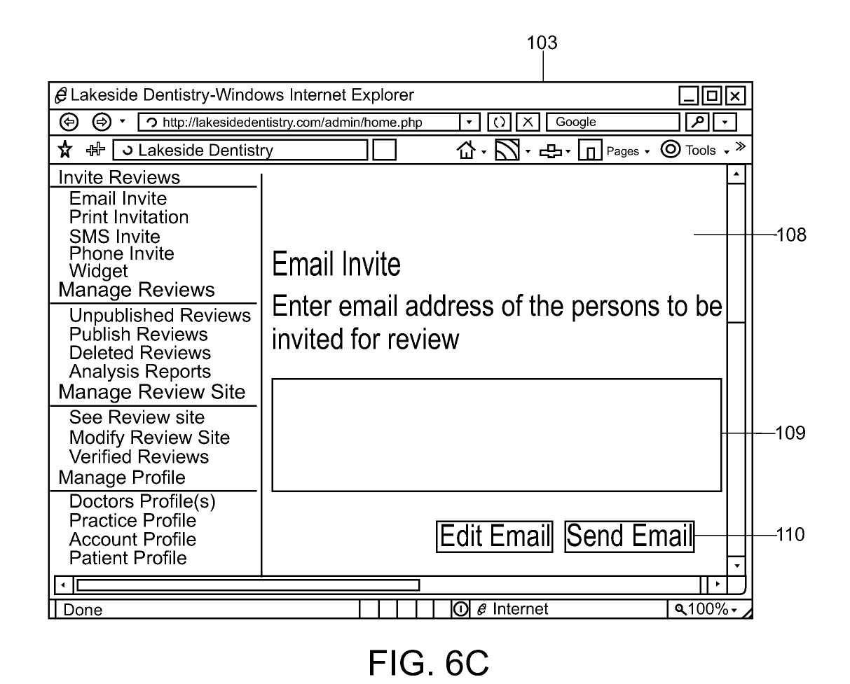

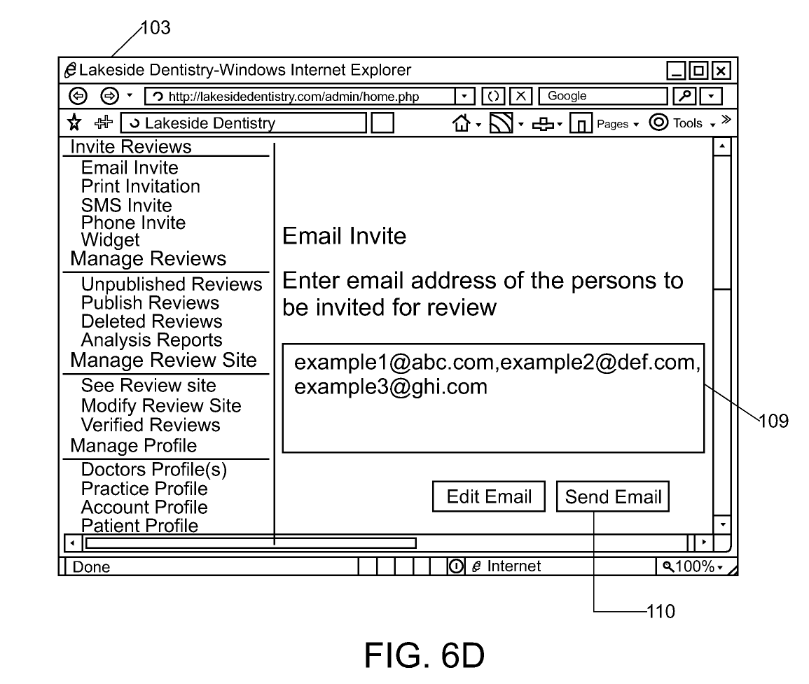

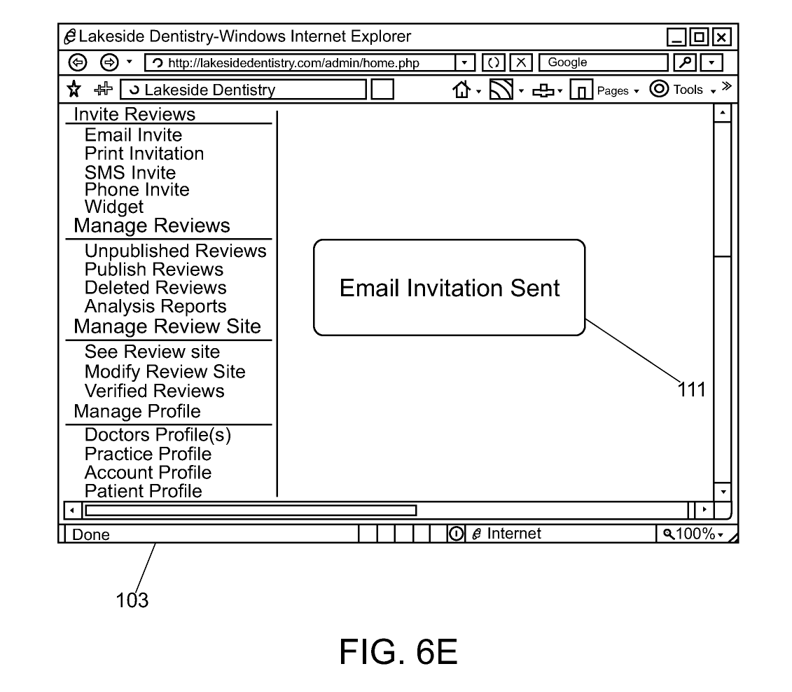

FIG. 6 illustrates an exemplary work flow 10 that the administrator follows to invite the entity to provide a review about the organization by using the email invitation method in accordance with one exemplary embodiment. According to this exemplary embodiment, the administrator accesses the first user interface 103 via a login page 140 and provides a username 142 and a password 144, and selects an authentication mechanism, such as a login button 146. The administrator is then presented with a user interface that includes the tools area 106 and the content area 108. The administrator selects the email invite tool 122 from the first set of tools 112 for inviting review from the entity.

The content related to the email invite tool 122 is displayed in the content area 108. The content area 108 includes a text input box 109 that allows the administrator to enter the e-mail address of one or more entities to be invited for providing a review about the organization. After entering the e-mail address of the entities in the text box 109, the administrator selects a send email button 110 or another mechanism to transmit the e-mail inviting reviews to the entities. If the e-mail invitation is successfully sent to the entity, a message 111 with information indicating that the e-mail was successfully sent is displayed to the administrator. If the e-mail invitation is not sent successfully then the administrator is notified accordingly (not shown).

In another exemplary embodiment, the email invitation method is completely automated by bridging the database used by the organization to store entities' email addresses and using that data to send email invitations to the entities automatically.

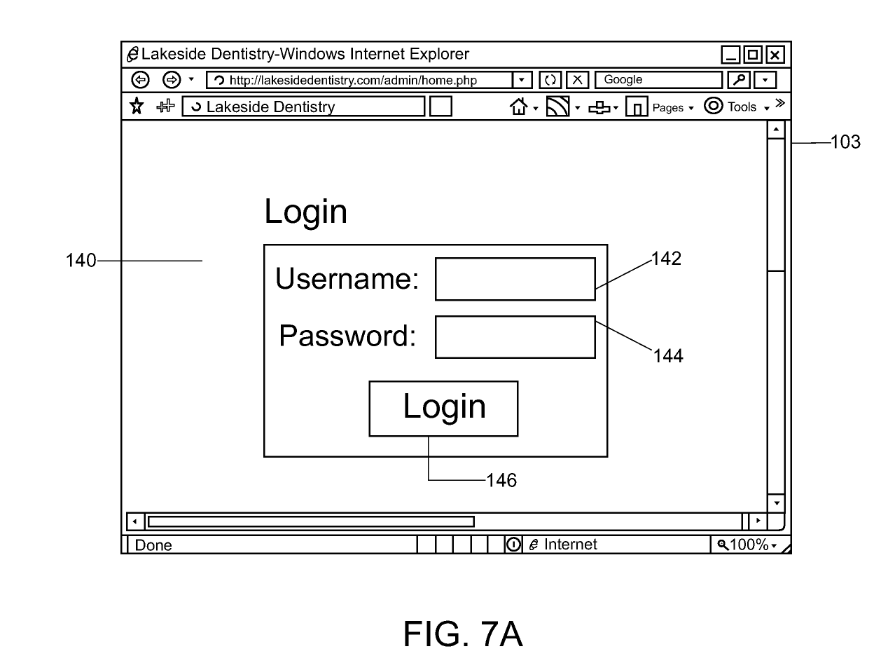

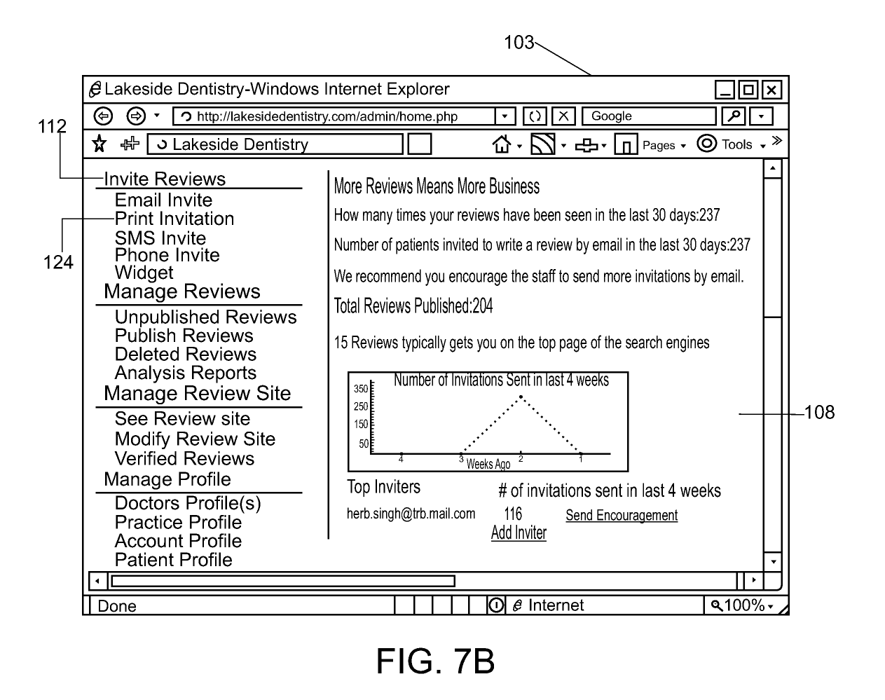

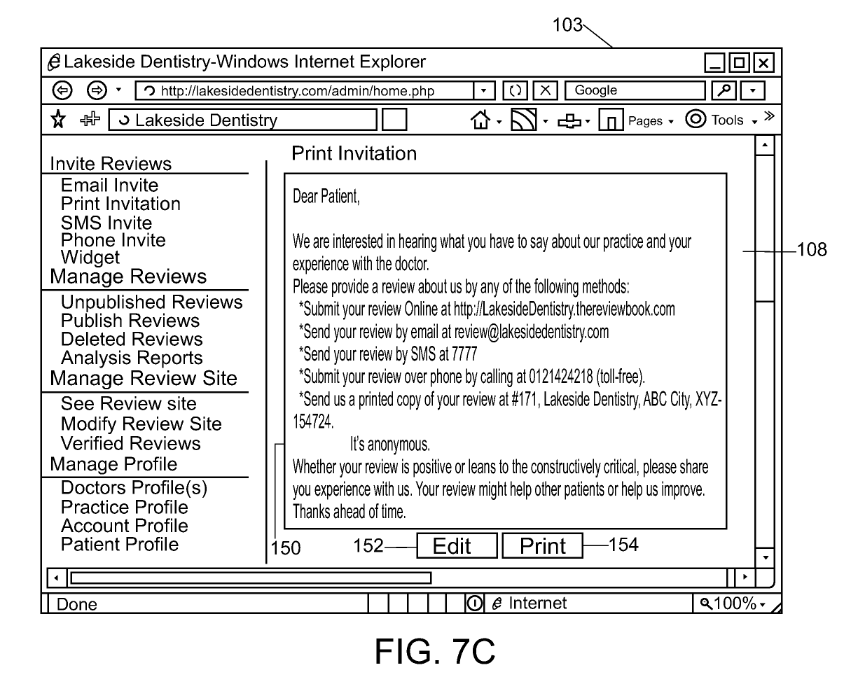

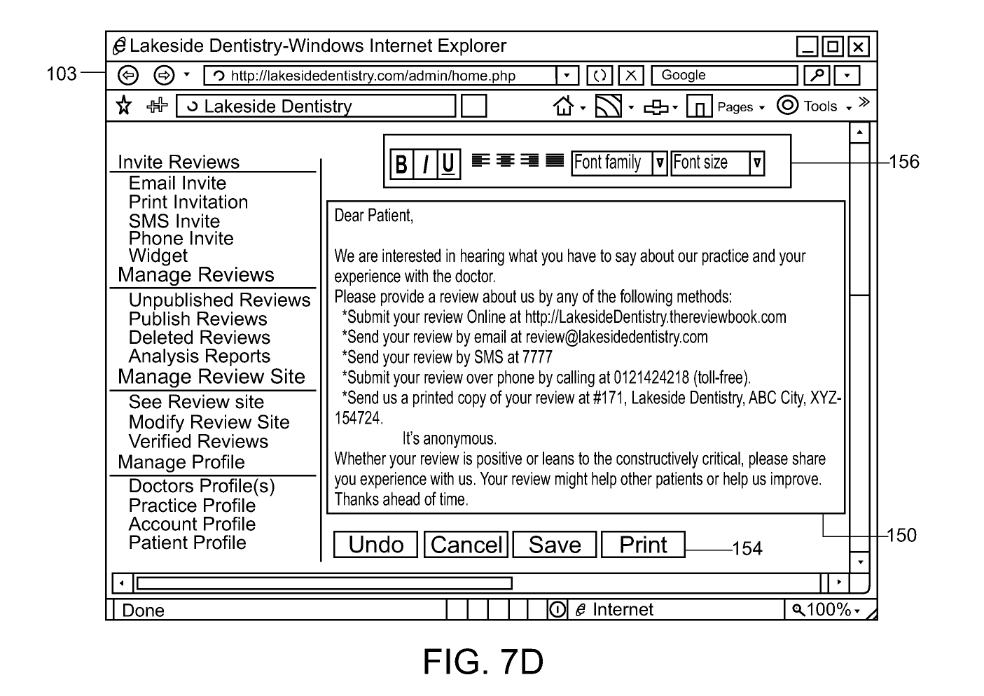

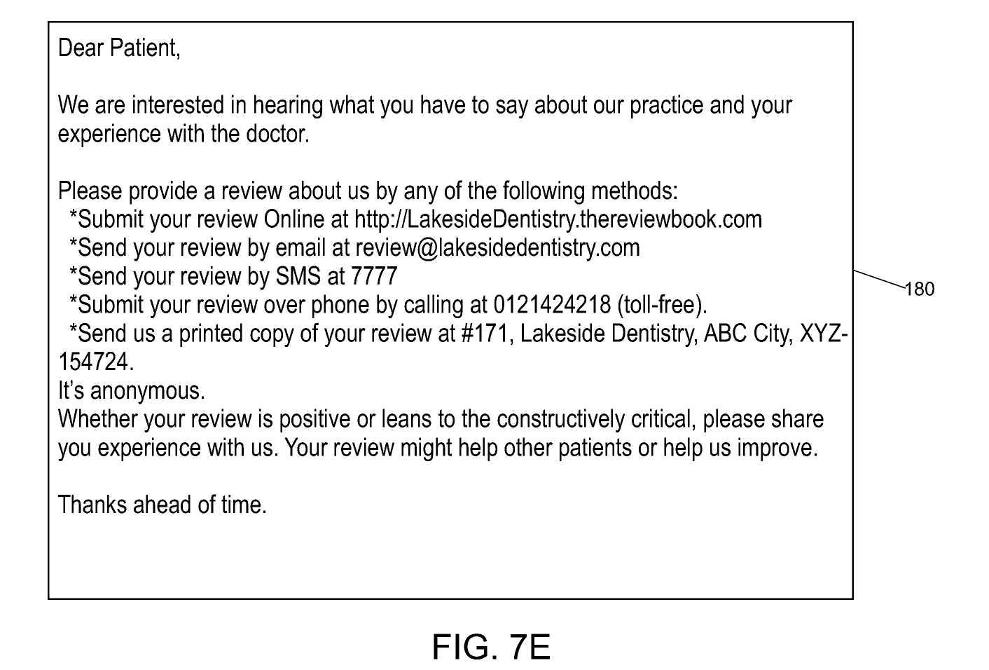

In still another exemplary embodiment, the invitation sent is a printed invitation. FIG. 7 illustrates an exemplary work flow 20 showing the process followed by the administrator to invite the entity to review the organization by using the printed invitation method. After logging in to the first user interface 103, the administrator selects the print invitation tool 124 from the first set of tools 112. The content related to the print invitation tool 124 is displayed in the content area 108. The content contains a preview 150 of the printable invitation and a list of tools to edit and print the printable invitation. By selecting the edit button 152, the administrator can customize the printable invitation using the edit tools 156 provided in the content area 108, and save the changes by selecting the save button 158 or any other mechanism. The administrator can print the customized invitation using the print button 154. The printed invitation 180 can be hand-delivered or mailed to the entities.

In still another exemplary embodiment, the entity is invited to provide the review about the organization via SMS. The administrator can send the SMS to the entity by any known method such as manually by a mobile or a computer or automatically by using software that automatically gets the entity's mobile number from the database and sends a SMS to that number.

In still another exemplary embodiment, the entity is invited to provide a review about the organization over phone.

In still another exemplary embodiment, a widget is used for gathering reviews, and is defined for this disclosure as follows. A “widget” is computer code that can be stored in an organization's website and allows the users visiting the website to submit their reviews and view the reviews submitted by others.

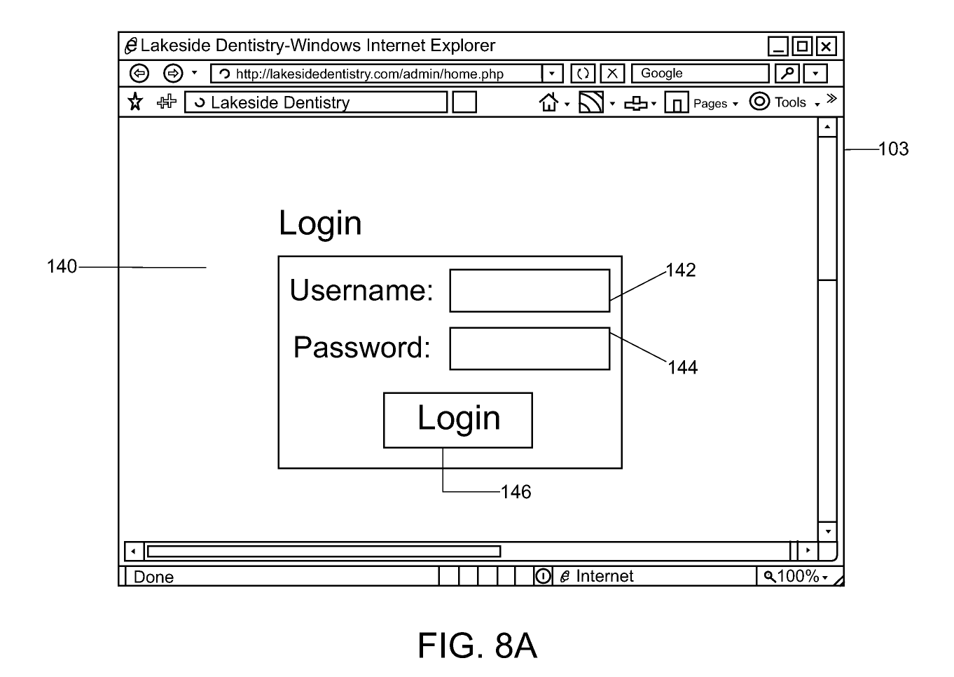

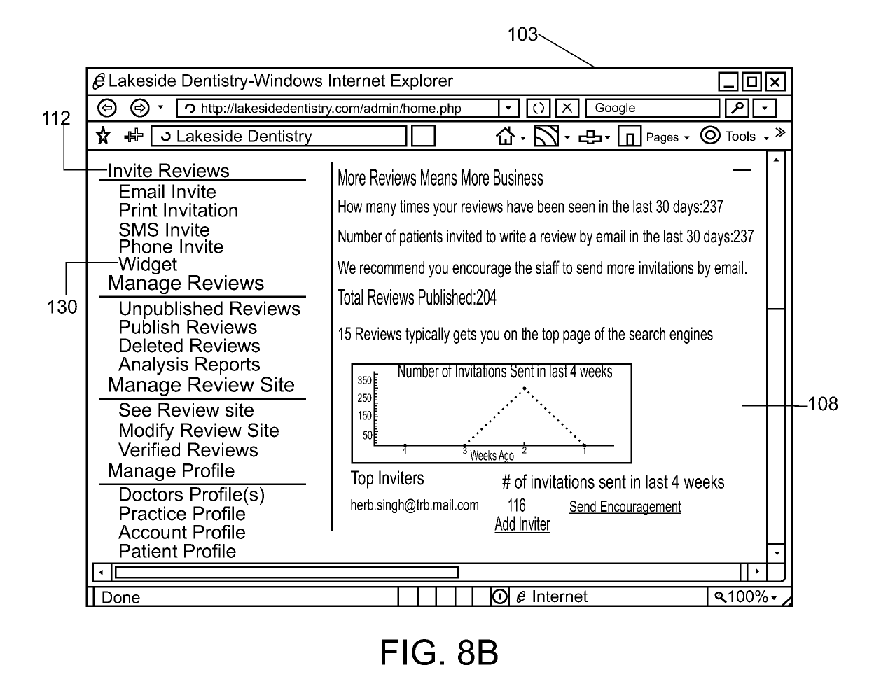

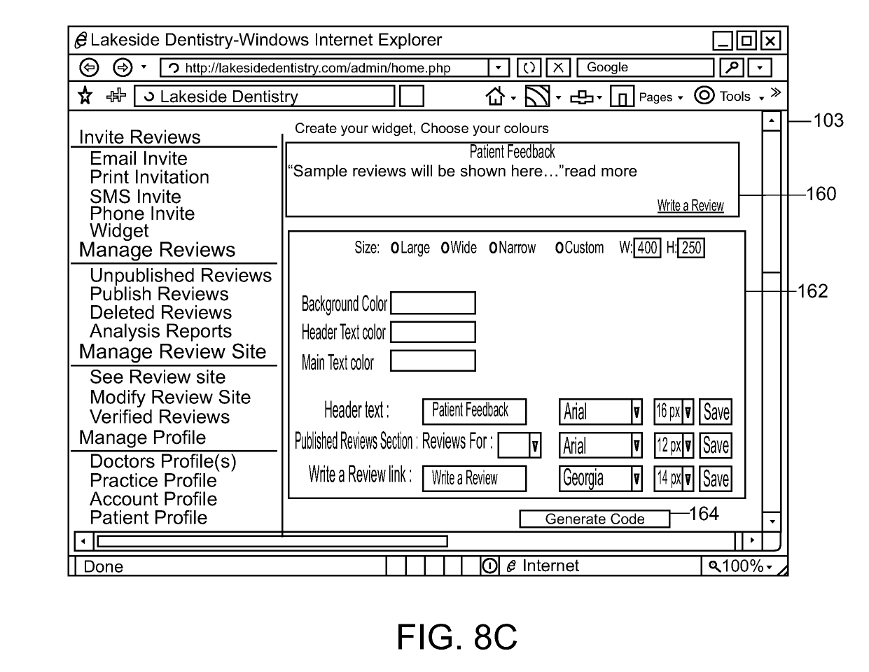

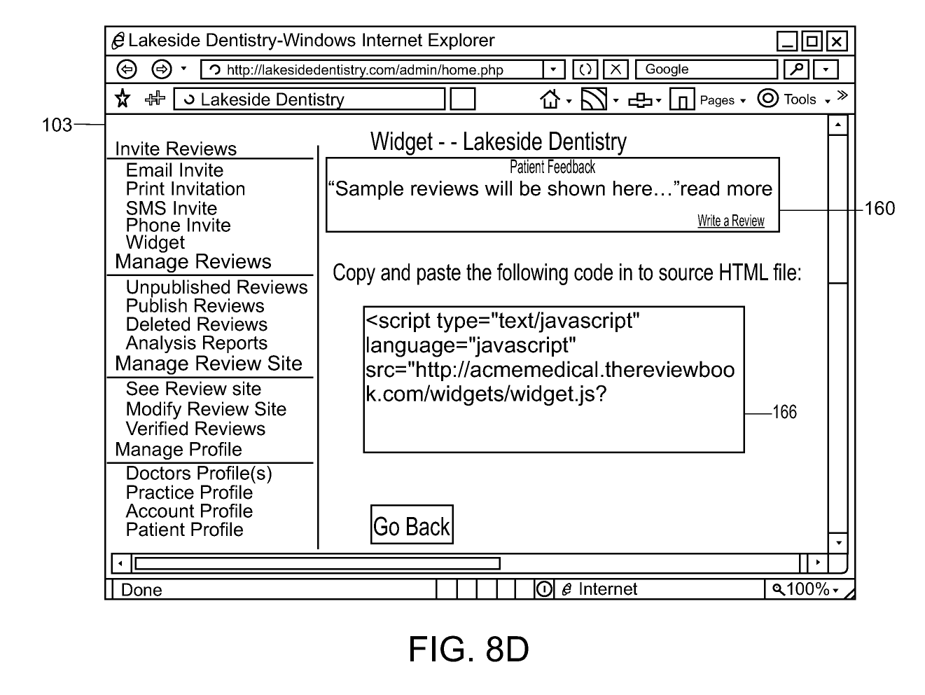

The administrator can generate the code for the widget using the first set of tools 112 as shown in the workflow 30 in FIG. 8. After logging in to the first user interface 103, the administrator selects the widget tool 130 from the first set of tools 112 present on the first user interface 103. The content related to the widget tool 130 is displayed in the content area 108. The content contains a preview 160 of the widget and a list of tools to edit and generate the widget code. The administrator can customize the size, color and content of the widget using the edit tools 162. Once the widget is created, the administrator can generate the widget code using a mechanism such as Generate Widget Code button 164. The generated code 166 can be placed on any website using methods known in to those skilled the art.

The invitation provides the entity with options to submit the review about the organization, including but not limited to, submitting a review online on a website, submitting review via e-mail, submitting a printed review, submitting review over phone and submitting review by SMS.

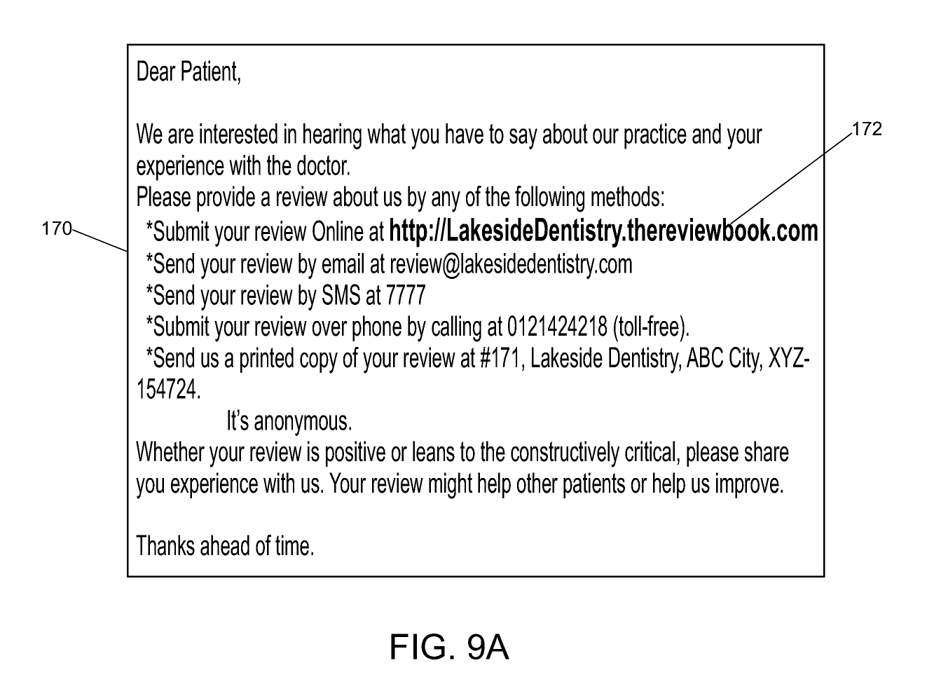

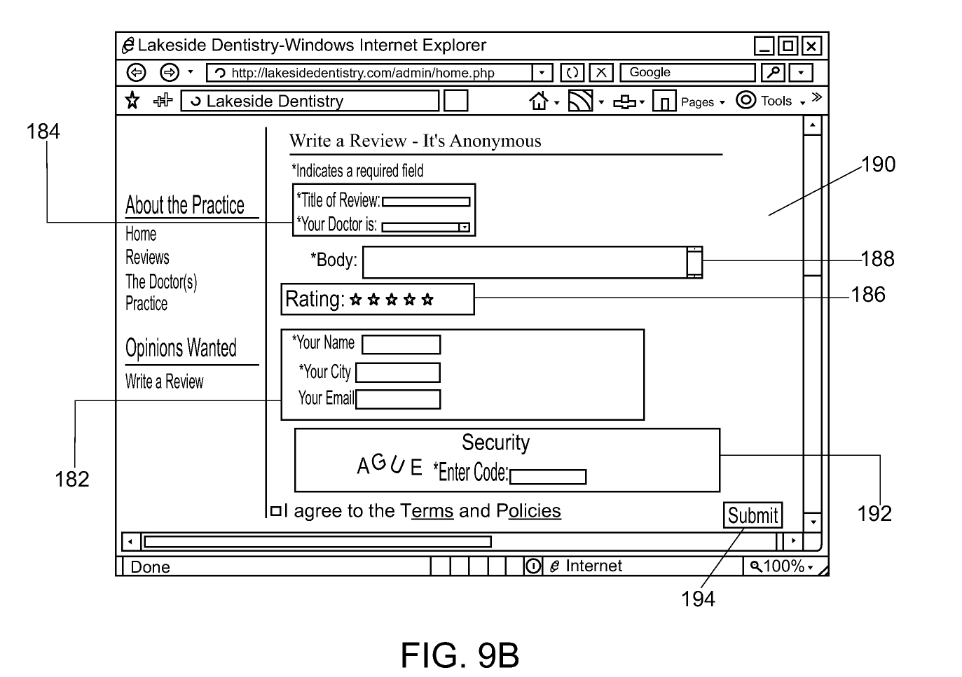

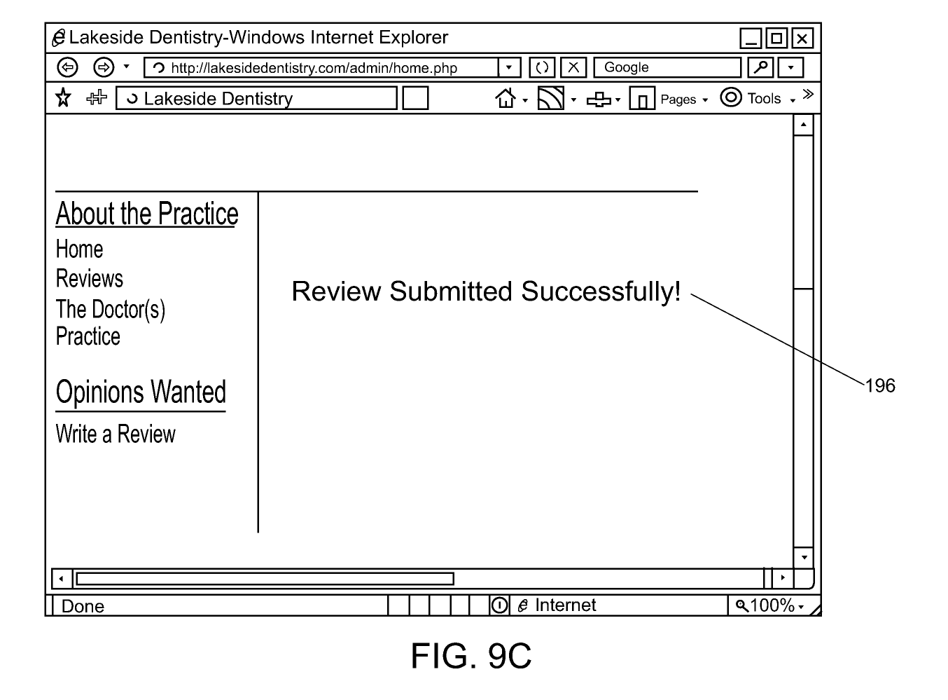

FIG. 9 illustrates an exemplary work flow 40 that the entity follows to submit the review online on a website in accordance with one exemplary embodiment. The entity accesses a hyperlink 172 included in the invitation 170 using an application such as a web browser. The link includes the URL of a website 190 that contains at least one of an entity information area 182, an organization information area 184, a rating area 186, a text area 188 and a security check area 192. The entity information area 182 has various fields such as entity name, address, phone number, e-mail address and screen name that the entity needs to provide. The organization information area 184 has fields like organization name and the product/service of the organization that is being reviewed by the entity. The rating area 186 allows the entity to rate the organization on one or more parameters using mechanisms known in the art such as on a scale of one to five. The text area 188 allows the entity to enter his/her comments/feedback/reviews about the organization. The security check area 192 is used to allow only a human entity to fill the information in various areas and prevents a robot or any other program from providing reviews that are not genuine. Further a question area (not shown) may also be provided that allows the organization to conduct a survey or ask questions from the entity. The areas or fields can be kept as mandatory or optional.

After the entity has entered information in these areas, the entity may select a send button 194 or another input mechanism. In one exemplary embodiment, the entity submits information to the content management server 101 for analysis at a later stage. To inform the entity that the review was successfully submitted to the content management server 101, a message 196 stating success or thanking the entity is displayed.

In another exemplary embodiment, the reviews can be submitted by the entity using e-mail, SMS, printed reviews or over phone. The reviews that are received may be converted into electronic form by methods known in the art, and are stored in the content management server 101 for further analysis.

The reviews received by the organization are viewed, analyzed and managed by the administrator using second set of tools 114 provided on the first user interface 103. The second set of tools 114 comprises tools for viewing published, unpublished or deleted reviews, tools for editing, previewing, publishing or deleting reviews and tools for analyzing and generating analysis reports from the reviews. Using these tools, the administrator can discard or delete reviews that are not genuine and edit reviews if required such as in case of a spelling mistake. The tools also allow the administrator to publish or display the reviews, and generate some useful information from the reviews. The useful information can be generated by means and methods known in the art.

The reviews and/or the analysis are provided to at least one third party for viewing and evaluating using the second user interface 105. The second user interface 105 can be customized and managed by the administrator using the third set of tools 116 provided on the first user interface 103. The third set of tools 116 comprises tools to view or modify the second user interface 105 and tools to categorize the reviews on the second user interface 105 such as arranging the results in the descending order with most featured review on the top or vice-versa.

In one exemplary embodiment, the second user interface 105 is a web based application such a website or a webpage. The webpage allows others to view the reviews submitted by entities and evaluate the organization based on the reviews. The second user interface can also be used to write or input the reviews.

The fourth set of tools 118 are used by the administrator to add, edit, delete or modify the information stored in the database.

In another exemplary embodiment, the organization is a local business such as but not limited to health care services, legal services, automotive services, accounting services/household services/home repair and improvement services, etc.

The method, algorithm or work flow described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

While exemplary embodiments have been illustrated and described, it will be clear that the present invention is not limited to these embodiments only. Numerous modifications, changes, variations, substitutions and equivalents will be apparent to those skilled in the art, without departing from the spirit and scope of the present invention, as described in the claims.

I claim:

1. A method for gathering and/or providing reviews, said method comprising:
storing first information about an organization in a database;
storing second information about an entity related to the organization in said database;
inviting said entity to review said organization using said first information and said second information;
storing a review by said entity in said database;
analyzing said review; and
selectively providing said review to at least one third party.

2. The method of claim 1, further comprising editing said review before said selectively outputting.

3. The method of claim 1, wherein said entity is invited to provide said review one of manually and automatically.

4. The method of claim 1, wherein said entity is invited to provide said review electronically or non-electronically.

5. The method of claim 1, wherein said inviting includes a request that invites said entity to submit a review electronically or non-electronically.

6. The method of claim 1, wherein said analyzing comprises validating whether said review is genuine.

7. The method of claim 1, further comprising preventing said third party from accessing said review based on a result of said analyzing step.

8. The method of claim 1, wherein said selectively outputting comprises displaying to a second user interface.

9. A system for reviewing an organization, comprising:
a content management server including a database configured to store data, wherein said data comprises information about said organization and information about an entity having a relationship with said organization;
a first user interface configured to receive an input from said server, wherein said first user interface comprises a first set of tools for soliciting review from said entity and a second set of tools for processing said review received from said entity; and
a second user interface that is linked to said server, said second user interface selectively providing said review received from said customer to at least one third party.

10. The system of claim 9, wherein said first user interface further comprises a third set of tools for managing said second user interface.

11. The system of claim 9, wherein said first user interface further comprises a fourth set of tools for adding, editing or deleting said information in said content management server.

12. The system of claim 9, wherein authorization access to said first user interface is restricted to an administrator.

13. The system of claim 9, wherein said first set of tools comprises at least one of an email invite, a customized printable invitation, a widget, an SMS invite and a phone invite.

14. The system of claim 9, wherein said second set of tools comprises tools to view, edit, discard, analyze or publish said review.

15. The system of claim 9, wherein said first user interface is a website.

16. The system of claim 9, wherein said second user interface is a website.
